(19) United States
(12) Patent Application Publication
(10) Pub. No.: US 2026/0293942 A1
(43) Pub. Date: Oct. 1, 2026

(54) INSTANT FOOD MIXTURE

(71) Applicant: Abu Dhabi University, Abu Dhabi (AE)

(72) Inventors: Nauman Khalid, Abu Dhabi (AE); Aqsa Akhtar, Abu Dhabi (AE); Iram Aslam, Abu Dhabi (AE)

(73) Assignee: Abu Dhabi University, Abu Dhabi (AE)

(21) Appl. No.: 19/096,298

(22) Filed: Mar. 31, 2025

(51) Int. Cl. A23L 7/143; A23L 5/10; A23L 33/16

(52) U.S. Cl. CPC A23L 7/143; A23L 5/13; A23L 33/16

(57) ABSTRACT

An instant rice mix includes steamed rice grains, potatoes, carrots, peas, cauliflower, and dehydrated chicken chunks.

### BACKGROUND

There is a demand for meals that can be cooked quickly and have good taste. Rice is a staple food, particularly in Asian countries, due to its impregnated caloric value.

The processing of rice-based porridges and congee (commonly known as liquid rice) for consumption is common practice around the globe. These liquid rice foods are usually prepared using various time and temperature combinations, the most common use temperature range is 90-110° C. However, this type of processed rice food cannot be stored for longer due to starch retrogradation problems, when stored at ambient temperatures. This retrogradation issue tends to limit the use of rice as processed food at the commercial level. A higher degree of retrogradation has been observed in rice grains containing more amylose content than amylopectin. The prior studies also reported that slower retrogradation occurs in rice kernels that have low amylose content.

To extend the shelf life of rice-based processed food, the most common use technique is canning. However, the problem of retrogradation is also reported in canned rice porridges when combined with duck meat. Moreover, such processed foods also exhibit Maillard reaction, discoloration, or darkening of the product due to the presence of reducing sugars inside the cans when stored for longer periods. These chemical changes promote lower consumer acceptability towards the product. Most of the time, the inside can line is found to be reactive with the liquid rice food, which tends to impart chromatic (color) changes in the product and accelerate the production of many hazardous chemical compounds. Moreover, the longer storage of rice congee with a meat-based blend at alleviated temperature (>55° C.) produced the constant vibrational motion in molecules that degrades the proteins and release the amino acid-based derivative including aspartic acid, glutamic acid, lysine, and methionine that lowers the pH of the product inside the can with the production of acidic contents.

The lowering of the pH inside the can accelerates the degradation of the can lining which ultimately lowers the product quality. The packaging of the rice-based liquid or semi-liquid food in the pouch packaging also exhibits changes in the physicochemical properties and lowers its overall acceptability. Accordingly, there is no current process that resolves any of the above noted issues.

While instant foods are available in the market and are considered a source of good caloric value, they are low with other nutritional and functional properties. These caloric foods are reported to promote chronic illnesses when consumed on regular basis. Plain rice foods are also found to impart only calories with the least providing the other beneficial nutrients, most significantly micronutrients. Although attempts are to formulate instant rice mix with different sugars and other confectionary materials, high nutritional value and disease modulation aspects are missing in them, which leads to low popularity in terms of functional attributes. Accordingly, at time there is no instant powder rice mix available in the market.

### BRIEF DESCRIPTION OF DRAWINGS

FIG. 1 is a flow diagram.

### DETAILED DESCRIPTION OF PREFERRED EMBODIMENTS

The following detailed description refers to the accompanying drawing. The same reference numbers in different drawings may identify the same or similar elements.

Systems, devices, and/or methods described herein may allow for a process of making an instant rice mix. In embodiments, the process includes dehydrating steamed rice (e.g., the broken rice kernels) and vegetables at pasteurization temperature, which is reconstituted in the presence of water at 80° C.; soaking the broken rice kernels in water with a water-to-rice ratio (4:1) for 35 mins; steaming the soaked rice kernels at a temperature of 70° C. for 15 mins in a steamer; fortifying the steamed rice kernels with active iron powder in a ratio of 6 mg (milligrams) per 100 g (grams) of the rice; drying the steamed iron-fortified rice kernels in a hot air oven at 55° C. for a period of time (such as three consecutive days); grinding of the rice kernels in a kitchen grinder to form coarse rice particles of approximately 1,000 microns in size; drying of vegetables (e.g., green peas, cauliflower and carrots) at 60° C. in a laboratory dehydrator for 72 hours; mixing (for 10 minutes or one to two minutes before 10 minutes) the dried rice kernels, dried chicken, dried vegetables, and spices (salt and black pepper) in a handheld mixer to form an instant rice mix; reconstituting 50 g of the instant rice mix in 150 mL of water which has been heated at 78° C. (water is heated); stirring the 50 g of instant rice mix in 150 mL water (75° C.) for 5 minutes to form a smooth slurry after reconstitution (e.g., mixing of instant rice mix with water). In embodiments, the addition of egg albumin proteins and flaxseed hydrocolloids may help with water-binding properties and prevents retrogradation in reconstituted instant rice mix. In embodiments, the instant rice mix exhibits a shelf life of up to six months in packaging (e.g., aluminum packaging).

Accordingly, the described process relates to Instant Rice Mix which is a carbohydrate and protein-based micronutrient-fortified instant powdered mix and can serve as the dynamic texture plate. It helps to boast immunity and body repairs due to a high-quality protein matrix. (immunity enhancement due to good quality proteins). In embodiment, the present process generates an instant powder meal that is prepared by combining rice, pulses, seeds, and chicken in a dehydrated form that exhibits extended shelf life, easy transportation over long distances, and convenience in availability for every type of population. In embodiments, the quick dehydration process (short mixing time) increases the storage stability (such as six months or greater), and an improved shelf life by up to six months.

Unlike the retrogradation issues which are common in existing commercial starchy products, the described process uses ingredients in dry form which can be reconstituted easily on rehydrating and can serve as ready-to-eat products. In embodiments, the ingredients for the development of this product is based on their low prices, easy availability, and most significantly to reduced rice milling and post-harvest vegetable losses. In embodiments, the product is developed using broken rice kernels generated during rice milling and vegetable waste generated during transportation. Being rich in low-cost sources of proteins both from animals and plants, the described Instant Rice Mix is a healthy substitute for the regular unhealthy starch-based instant food cereals significantly noodles. In embodiments, the fortification of active iron (Fe) powder (6 mg per 100 g) on the rice using dusting technology followed by drying and making the Instant Rice Mix unique and micro-nutrient rich that addresses many health issues associated with Fe deficiency.

Accordingly, the described instant rice mix is developed with the aim to provide a healthy instant powder mix that is made of rice, proteins, and seeds and stabilized by adjusting the process control variables. This powdered rice mix exhibited tremendous benefits over the traditional rice congee (liquid food). Furthermore, the retrogradation issue are resolved by using the ingredients in dry form and combining them with many plant-based hydrocolloids. In embodiments, the instant rice mix is a powdered blend (instant mix) of ingredients that are packaged under controlled conditions.

In embodiments, the described instant rice mix, after reconstitution in water at its optimum temperature of 78° C., can form a viscous rice paste of coarse particles. While the optimum temperature in this example may be 78° C., other temperatures may be used such as at a temperature range of 75° C. to 85° C. In embodiments, the instant rice mix is prepared by incorporating steaming and closed chamber drying technology (e.g., a hot air oven) to dehydrate the ingredients. In embodiments, the described instant rice mix is retained over longer periods of up to 6 months. This product is packaged in aluminum packaging (or another type of packaging) that ensures high-end product quality and microbiological safety.

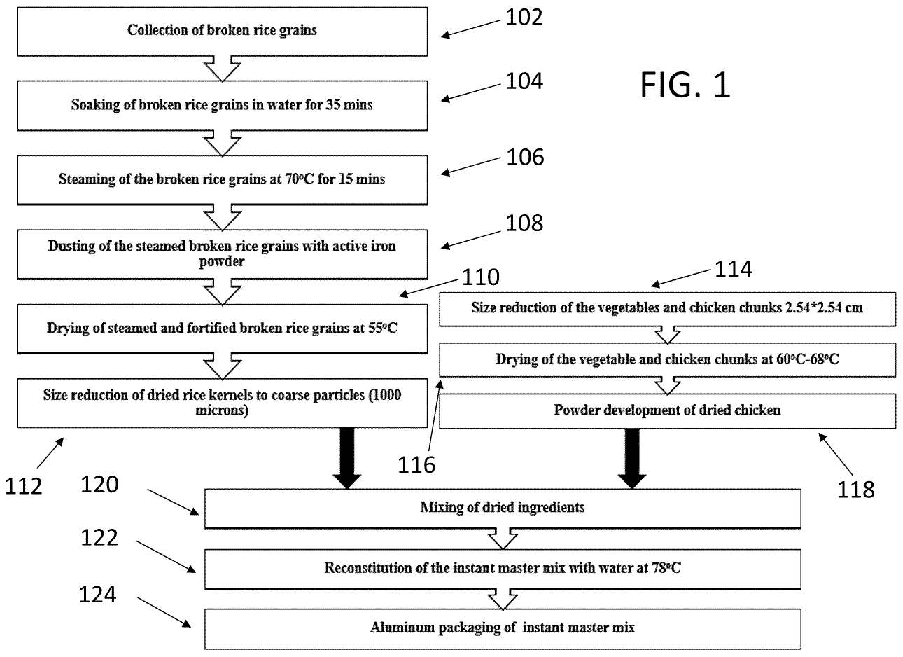

FIG. 1 is a flowchart of an example process for making an instant rice mix. At step 102, for the production of instant rice mix, milled rice waste is used. In embodiments, the broken rice is collected mainly from a Japonica variety. This variety tends to impart more consistency than the Indica rice variety. However, other varieties of broken rice may be used. At step 104, the broken rice grams are soaked in water. In embodiments, after proper cleaning and sifting, the broken rice grains are soaked in water with a water-to-rice ratio of 4:1 for 35 minutes. In embodiments, the time for soaking may range from 25 minutes to 35 minutes. In embodiments, the water-to-rice ratio is specified for the sufficient water absorption in the broken rice kernels that softens the polymeric linkages and initiates the gelatinization process.

At step 106, the soaked rice grains are then steamed at a temperature of 70° C. for 15 minutes in a steamer. In embodiments, by increasing the soaking time of broken rice kernels in the water, the steaming temperature is reduced which prevents color changes and controls excessive retrogradation. At step 108, fortification of the boiled rice grains is conducted. In embodiments, the active Fe powder in a ration of 6 mg/ 100 g of the rice is dusted on the steamed rice. At step 110, the rice kernels are dried. After steaming and dusting the rice broken grains are dried in the hot air oven at 55° C. (or within a range of 50° C. to 60° C.). While the normal drying temperature of rice kernels is 100° C., but this temperature can turn the rice brown and burned. Therefore, the use of a 55° C. temperature for three (or five) consecutive days can significantly reduce the moisture (<10%) from the steamed rice. In embodiments, this dried rice is then aged at 25° C. for eight hours in a closed chamber.

At step 112, after drying, the rice grains are subjected to lab grinders to form coarse rice particles of approximately 1,000 microns in size and stored in an airtight jar. At step 114, vegetables used in the processing of instant rice mix are included peas, carrots, potatoes, and cauliflower. In embodiments, the vegetables are reduced in size by manual size reduction and turned into chunks of 2.54*2.54 cm. Also, boneless breast meat pieces of chicken are reduced to the size of 2.54*2.54 cm and boiled for 10 mins at 90° C.

At step 116, the vegetable chunks are dried at 60° C. in a dehydrator for 72 hours. During the process of drying, the vegetables are turned over to ensure efficient heat transfer and avoid burning. Also, the chicken chunks are dried at 68° C. for 72 hours in the hot air oven with frequent turning over to avoid browning. The chicken and vegetables may be dried at the same time or at different times. At step 118, a few portions (35%) of dried chicken are further dried at 68° C. for 72 hours in a hot air oven and is milled to form a fine chicken powder in a laboratory grinder.

At step 120, all the dried ingredients including the dried rice, chicken chunks, chicken powder, dried vegetables, and spices in a specified proportion (3%) are mixed using a hand-held laboratory mixer. In embodiments, the guar gum and egg albumin are added in the ratio of 0.25% and 0.5%, respectively. In embodiments, flaxseed powder in 0.5% concentration is added to enhance water-binding properties. Accordingly, the details of the ingredients used in the described instant rice mix is: dehydrated broken rice coarse grains at 75 g; dehydrated potatoes at 15 g; dehydrated carrots at 15 g; dehydrated peas at 25 g; dehydrated cauliflower at 25 g; egg proteins at 0.5 g; flax seed powder at 0.5 g; chicken chunks at 35 g; chicken powder at 0.1 g; salt at 1.25 g; black pepper at 1.75 g; corn flour at 1.25g; and guar gum at 0.25 g. At step 122, reconstitution of the instant rice mix is performed. In embodiments, for the reconstitution of the instant rice master mix, first, 150 mL of water is subjected to heating at 78° C. in a lab-used pan followed by the addition of the 50 g of instant rice mix and stirred properly for five minutes until all the constituents get rehydrated. At step 124, the described instant rice mix is packaged. In embodiments, 50 g of the instant rice mix is packed in an aluminum foil that has a shelf life of up to 6 months. In embodiments, the aluminum foil packaging acts as an efficient barrier to moisture and light.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method for making the instant rice mix, comprising:
soaking broken rice grains in water with a water-to-rice ratio (4:1);
steaming the broken rice grains at a temperature;
fortifying the steamed rice kernels with active iron powder;
drying the steamed iron-fortified rice kernels in a hot air oven;
grinding the rice kernels to form rice particles of about 1,000 microns in mixing the rice particles with vegetables, dried chicken, and spices,
wherein the vegetables include potatoes, carrots, peas, and cauliflower; and
generating an instant rice mix.

2. The method of claim 1, the water includes flax seed powder.

3. The method of claim 1, wherein the active iron powder fortification by dusting method on steamed rice.

4. The method of claim 1 wherein powdered egg white (albumin) proteins is used in the instant rice mix to reduce retrogradation.

5. The method of claim 1, wherein the generating the instant rice mix includes a blend of cornstarch and guar gum to induce thickening and maintained consistency in the instant rice mix after reconstitution.

6. An instant rice mix, comprising:
steamed rice grains;
potatoes;
carrots;
peas;
cauliflower; and
dehydrated chicken chunks.
